(19) United States
(12) Patent Application Publication
(10) Pub. No.: US 2016/0163181 A1
(43) Pub. Date: Jun. 9, 2016

(54) WEARABLE ALRAM CLOCK

(71) Applicant: Intel Corporation, Santa Clara, CA (US)

(72) Inventors: Dor Levy, Jerusalem (IL); Nir Parisian, Jerusalem (IL)

(21) Appl. No.: 14/562,889

(22) Filed: Dec. 8, 2014

(51) Int. Cl. G08B 25/00; G08B 25/10

(52) U.S. Cl. CPC G08B 25/008; G08B 25/10

(57) ABSTRACT

Various systems and methods for a wearable alarm clock are described herein. A wearable alarm clock system includes an alarm module to signal an alarm from a mobile device associated with a user, the mobile device communicatively coupled to a wearable device worn by the user; an activity module to detect a physical activity performed by the user; and a user interface module to allow the alarm to be disabled in response to detecting that the physical activity was performed.

### TECHNICAL FIELD

Embodiments described herein generally relate to user interfaces and in particular, to a wearable alarm clock.

### BACKGROUND

Alarm clocks are used to wake a person at a specific time. However, due to their design, many alarm clocks are easily defeated. For example, a person may repeatedly use a snooze function or simply disable the alarm in a state of semi-consciousness, only to later realize that they have slept through an important event.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a wearable alarm clock system, according to an embodiment;

FIG. 2 is a flowchart illustrating the use of a wearable alarm clock, according to an embodiment;

FIG. 3 is a block diagram illustrating a wearable alarm clock system, according to an embodiment; and

FIG. 4 is a flowchart illustrating a method for implementing a wearable alarm clock, according to an embodiment; and

FIG. 5 is a block diagram illustrating an example machine upon which any one or more of the techniques (e.g., methodologies) discussed herein may perform, according to an example embodiment.

### DETAILED DESCRIPTION

Systems and methods described herein provide a wearable alarm clock. In contrast to many alarm clocks that simply provide an alarm or other acoustic signal (e.g., music, ringtone, chime, etc.), the alarm clock described in this disclosure senses the user's physical actions and only is allowed to be disabled after sensing a certain type or number of certain actions. By requiring the user to interact more consciously with the alarm clock to actively disable the alarm, the alarm clock is more effective in waking the user. Other operations are discussed as well.

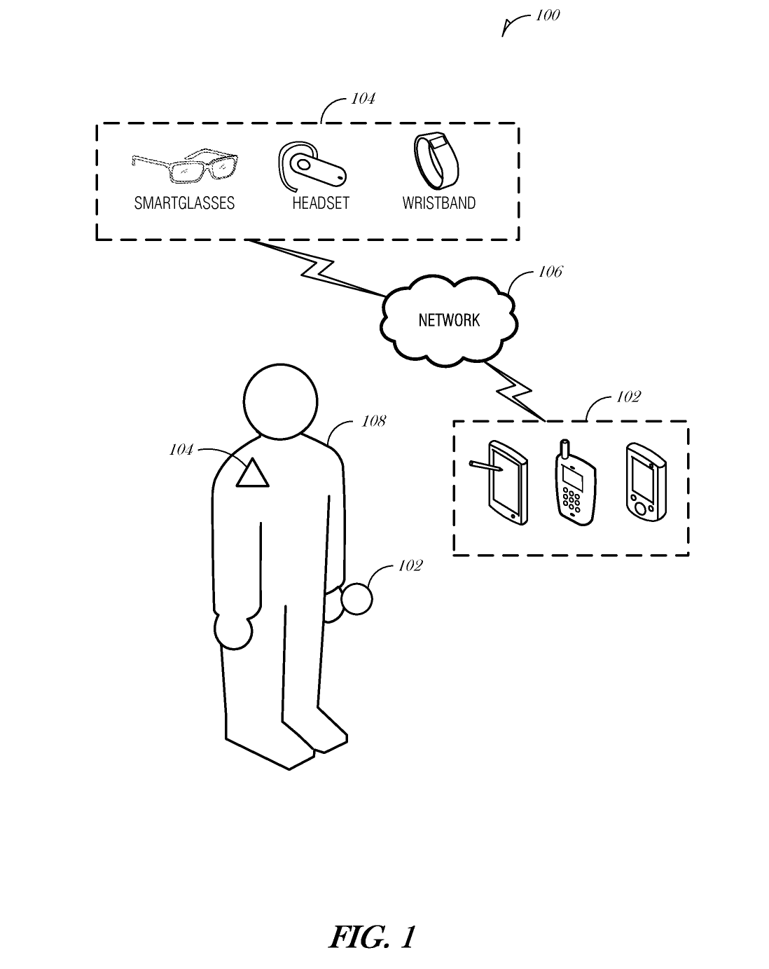

FIG. 1 is a schematic drawing illustrating a wearable alarm clock system 100, according to an embodiment. The wearable alarm clock system 100 includes a mobile device 102 and a wearable device 104, connected via a network 106. The mobile device 102 may be any type of device, such as mobile phone, a tablet, a hybrid device, a smartphone, a personal digital assistant, or the like. The mobile device 102 hosts an alarm clock application, which may be configured by a user to set the time, set one or more alarms or alarm preferences. While a mobile device 102 is discussed in the context of FIG. 1, it is understood that any device that is able to provide an alarm may be used in place of the mobile device 102.

The wearable device 104 may be any type of wearable device, such as an earpiece, a glasses-based device, a headset, a wristband, a shoe insert, or the like. In general, the wearable device 104 is used to sense physical activity directly (e.g., with an accelerometer) or indirectly (e.g., by monitoring heart rate). Thus, the wearable device 104 may include one or more sensors such as a proximity sensor, accelerometer, pedometer, heart rate sensor, skin temperature sensor, global positioning system, or the like.

The mobile device 102 and the wearable device 104 may be connected via the network 106, which may be a short range network such as Bluetooth low energy, or a long range network such as Wi-Fi. It is understood that any type of network may be used. The network may be secured with encryption or other security.

In some cases, the mobile device 102 and the wearable device 104 may be integrated into one device. For example, the wearable device 104 may by a watch or a glasses-based device with a speaker to provide audio output and an interface to allow user interaction. As such, the wearable device 104 may provide both the alarm clock function and the physical activity monitoring function.

To use the wearable alarm clock system 100, a user 108 configures the alarm clock application on the mobile device 102 with at least an alarm time. In some cases, the user 108 may choose a physical activity to disable the alarm. In other cases, the physical activity may be selected by the alarm clock application. For example, the alarm clock application may select a physical activity that is part of an exercise regimen or may select a random physical activity to surprise the user 108 and force the user 108 into a more conscious state of mind Physical activities include various exercises or actions that are independent of interaction with the mobile device 102. Examples of physical activities include walking, running, jumping, swimming, biking, weight lifting, or other exercises or calisthenics.

After the alarm clock application has been configured, the user 108 may rest until the alarm clock goes off at the designated time. When the alarm is active, the user 108 is notified to perform a certain physical activity (e.g., ten jumping jacks). The alarm clock application on the mobile device 102 communicates with the wearable device 104 to gather activity data that indicates that the user 108 performed the physical activity. After detecting that the user 108 performed the required physical activity, the alarm clock application will then allow the user 108 to disable the alarm. Alternatively, the alarm may disable itself upon detecting that the user 108 performed the required physical activity. For longer activities, the alarm clock application may temporarily suspend the alarm for a better user experience. For example, if the required activity is to run 500 meters, the alarm need not continue for several minutes, but may suspend itself while the wearable device 104 indicates that the activity is being performed (e.g., the user is jogging). After the user 108 finishes the required amount of running, the alarm clock application may unlock so that the user 108 may then disable the alarm or the alarm may disable automatically based on the completion of the required physical activity.

While an alarm may typically be used to wake a person from rest, the wearable alarm system 100 described here may be used in other ways as well. For example, the wearable alarm system 100 may be used to enforce a training regimen by requiring a person to perform certain activities daily, weekly, or at other regular intervals. The activities may change day-to-day to provide a full body workout or cross training. The activities may also change to become progressively more difficult.

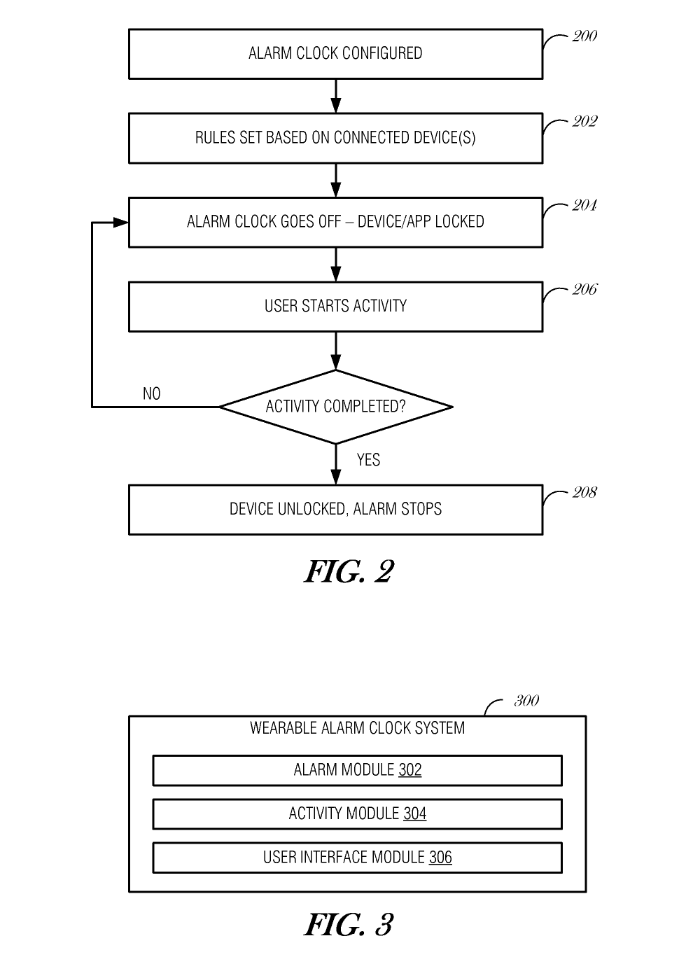

FIG. 2 is a flowchart illustrating the use of a wearable alarm clock, according to an embodiment. At 200, the user configures the alarm clock. Rules may be set based on the devices connected to the alarm clock device (block 202). For example, when the alarm clock device is connected to a device that is a shoe insert used to track a number of steps or a distance run, the alarm clock device may provide the user activities such as running or walking a certain distance, jumping jacks, stationary steps, or some other activity that the shoe insert is configured to monitor. As another example, if the alarm clock device is connected to a wristband device that is able to detect heart rate, then the user may be able to configure a rule based on a heart rate (e.g., raise heart rate to a certain BPM or over a BPM for certain amount of time).

At block 204, the alarm clock goes off and the alarm clock application is locked, preventing the user from disabling the alarm. At block 206, the user starts the activity associated with the alarm. If the activity is not completed, then the flow transitions to block 204 and the alarm clock application remains locked. Once the activity is completed, the alarm clock application or the alarm clock device is unlocked, allowing the user to disable the alarm (block 208). Alternatively, the alarm may be automatically disabled at block 208 after the activity is completed.

FIG. 3 is a block diagram illustrating a wearable alarm clock system 300, according to an embodiment. The system 300 may be implemented in a mobile device, such as mobile device 102, or may be incorporated into various other forms of devices, such as a laptop, desktop, or the like. Some or all of the processing may be performed local to the user (e.g., in the mobile device 102) or remote from the user (e.g., in a cloud service).

The system 300 includes an alarm module 302, an activity module 304, and a user interface module 306. The alarm module 302 may be configured to signal an alarm from a mobile device associated with a user, where the mobile device is communicatively coupled to a wearable device associated with the user. The activity module 304 may be configured to detect a physical activity performed by the user. The user interface module 306 may be configured to allow the alarm to be disabled in response to detecting that the physical activity was performed.

In an embodiment, the wearable device comprises a watch. In an embodiment, the wearable device comprises a wristband. In an embodiment, the wearable device comprises a shoe insert.

In an embodiment, the user interface module 306 is to provide a user interface to the user to set the physical activity to disable the alarm and receive from the user, the physical activity. In an embodiment, the physical activity comprises running a threshold distance. For example, the physical activity may be to run 100 meters. In an embodiment, the physical activity comprises taking a threshold number of steps. In an embodiment, the physical activity comprises performing a threshold number of pushups.

In an embodiment, the physical activity is a portion of a training regimen; and to detect the physical activity performed by the user, the activity module 304 is to detect that the user is complying with the training regimen.

In an embodiment, to allow the alarm to be disabled, the user interface module 306 is to unlock an alarm application on the wearable device and receive user input from the user to access the alarm application and disable the alarm. Alternatively, in another embodiment, to allow the alarm to be disabled, the user interface module 306 is to automatically disable the alarm in response to detecting that the physical activity was performed.

In an embodiment, the physical activity is one of a plurality of physical activities to be performed in a sequence, and to detect the physical activity performed by the user, the activity module 304 is to detect that the plurality of physical activities were performed by the user in the sequence. For example, the physical activity may be a sequence of ten jumping jacks, running 50 meters, and then walking for 100 steps.

In an embodiment, the activity module 304 is to detect user activity that is related to the physical activity and the alarm module 302 is to suspend the alarm while the user activity is occurring.

In an embodiment, the activity module 304 is to select the physical activity from a plurality of physical activities and the user interface 306 module is to present the physical activity to the user. In an embodiment, to select the physical activity from the plurality of physical activities, the activity module 304 randomly selects the physical activity from the plurality of physical activities.

In an embodiment, the plurality of physical activities is identified by the user and the activity module 304 is to randomly select the physical activity from the plurality of physical activities. For example, the user may provide a list of several activities that the user is willing or capable of performing and then allow the wearable alarm clock system 300 to select an activity. Such a configuration may provide relief from routine workouts.

In an embodiment, the plurality of physical activities is correlated to a plurality of days, and to select the physical activity, the activity module 304 is to select the physical activity based on a current day. For example, the user may configure a light run on Monday (e.g., 5 km), a calisthenics workout on Tuesday (e.g., jumping jacks), and then a heavy run on Thursday (e.g., 25 km). The activity module 304 may identify the current day and then adaptively select the activity based on the day.

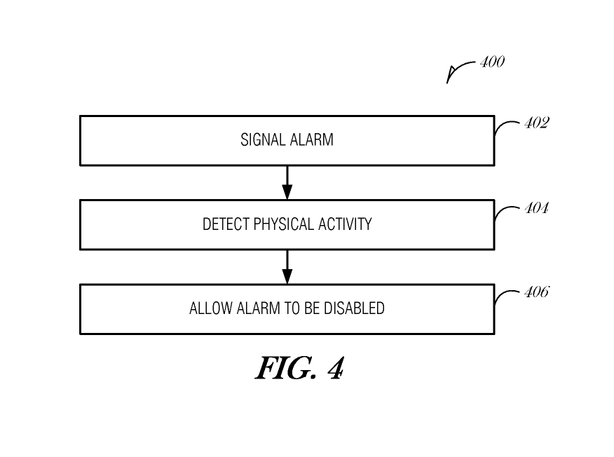

FIG. 4 is a flowchart illustrating a method 400 for implementing a wearable alarm clock, according to an embodiment. At block 402, an alarm is signaled from a mobile device associated with a user, where the mobile device is communicatively coupled to a wearable device worn by the user. At block 404, a physical activity performed by the user is detected. At block 406, the alarm is allowed to be disabled in response to detecting that the physical activity was performed.

In an embodiment, the wearable device comprises a watch. In an embodiment, the wearable device comprises a wristband. In an embodiment, the wearable device comprises a shoe insert.

In an embodiment, the method 400 includes providing a user interface to the user to set the physical activity to disable the alarm and receiving from the user, the physical activity.

In an embodiment, the physical activity comprises running a threshold distance. In an embodiment, the physical activity comprises taking a threshold number of steps. In an embodiment, the physical activity comprises performing a threshold number of pushups.

In an embodiment, the physical activity is a portion of a training regimen; and detecting the physical activity performed by the user comprises detecting that the user is complying with the training regimen.

In an embodiment, allowing the alarm to be disabled in response to detecting that the physical activity was performed comprises unlocking an alarm application on the wearable device and receiving user input from the user to access the alarm application and disable the alarm.

In an embodiment, allowing the alarm to be disabled in response to detecting that the physical activity was performed comprises automatically disabling the alarm in response to detecting that the physical activity was performed.

In an embodiment, the physical activity is one of a plurality of physical activities to be performed in a sequence, and wherein detecting the physical activity performed by the user comprises detecting that the plurality of physical activities were performed by the user in the sequence.

In an embodiment, the method 400 includes detecting user activity that is related to the physical activity and suspending the alarm while the user activity is occurring.

In an embodiment, the method 400 includes selecting the physical activity from a plurality of physical activities and presenting the physical activity to the user.

In an embodiment, selecting the physical activity from the plurality of physical activities is performed by randomly selecting the physical activity from the plurality of physical activities.

In an embodiment, the plurality of physical activities is identified by the user and wherein the physical activity is randomly selected from the plurality of physical activities.

In an embodiment, the plurality of physical activities is correlated to a plurality of days, and wherein selecting the physical activity comprises selecting the physical activity based on a current day.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

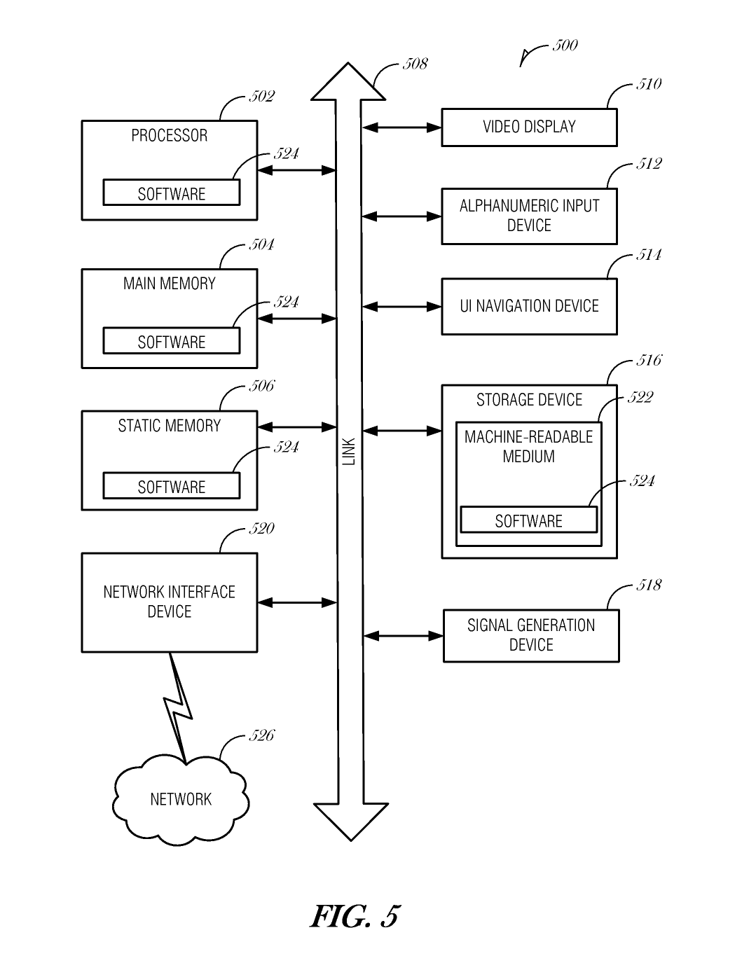

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 includes subject matter for a wearable alarm clock system (such as a device, apparatus, or machine) comprising: an alarm module to signal an alarm from a mobile device associated with a user, the mobile device communicatively coupled to a wearable device worn by the user; an activity module to detect a physical activity performed by the user; and a user interface module to allow the alarm to be disabled in response to detecting that the physical activity was performed.

In Example 2, the subject matter of Example 1 may include, wherein the wearable device comprises a watch.

In Example 3, the subject matter of Example 1 may include, wherein the wearable device comprises a wristband.

In Example 4, the subject matter of Example 1 may include, wherein the wearable device comprises a shoe insert.

In Example 5, the subject matter of any one of Examples 1 to 4 may include, wherein the user interface module is to: provide a user interface to the user to set the physical activity to disable the alarm; and receive from the user, the physical activity.

In Example 6, the subject matter of any one of Examples 1 to 5 may include, wherein the physical activity comprises running a threshold distance.

In Example 7, the subject matter of any one of Examples 1 to 6 may include, wherein the physical activity comprises taking a threshold number of steps.

In Example 8, the subject matter of any one of Examples 1 to 7 may include, wherein the physical activity comprises performing a threshold number of pushups.

In Example 9, the subject matter of any one of Examples 1 to 8 may include, wherein the physical activity is a portion of a training regimen; and wherein to detect the physical activity performed by the user, the activity module is to detect that the user is complying with the training regimen.

In Example 10, the subject matter of any one of Examples 1 to 9 may include, wherein to allow the alarm to be disabled, the user interface module is to: unlock an alarm application on the wearable device; and receive user input from the user to access the alarm application and disable the alarm.

In Example 11, the subject matter of any one of Examples 1 to 10 may include, wherein to allow the alarm to be disabled, the user interface module is to: automatically disable the alarm in response to detecting that the physical activity was performed.

In Example 12, the subject matter of any one of Examples 1 to 11 may include, wherein the physical activity is one of a plurality of physical activities to be performed in a sequence, and wherein to detect the physical activity performed by the user, the activity module is to: detect that the plurality of physical activities were performed by the user in the sequence.

In Example 13, the subject matter of any one of Examples 1 to 12 may include, wherein the activity module is to detect user activity that is related to the physical activity; and wherein the alarm module is to suspend the alarm while the user activity is occurring.

In Example 14, the subject matter of any one of Examples 1 to 13 may include, wherein the activity module is to select the physical activity from a plurality of physical activities; and wherein the user interface module is to present the physical activity to the user.

In Example 15, the subject matter of any one of Examples 1 to 14 may include, wherein to select the physical activity from the plurality of physical activities, the activity module randomly selects the physical activity from the plurality of physical activities.

In Example 16, the subject matter of any one of Examples 1 to 15 may include, wherein the plurality of physical activities is identified by the user and wherein the activity module is to randomly select the physical activity from the plurality of physical activities.

In Example 17, the subject matter of any one of Examples 1 to 16 may include, wherein the plurality of physical activities is correlated to a plurality of days, and wherein to select the physical activity, the activity module is to: select the physical activity based on a current day.

Example 18 includes subject matter for implementing a wearable alarm clock (such as a method, means for performing acts, machine readable medium including instructions that when performed by a machine cause the machine to performs acts, or an apparatus to perform) comprising: signaling an alarm from a mobile device associated with a user, the mobile device communicatively coupled to a wearable device worn by the user; detecting a physical activity performed by the user; and allowing the alarm to be disabled in response to detecting that the physical activity was performed.

In Example 19, the subject matter of Example 18 may include, wherein the wearable device comprises a watch.

In Example 20, the subject matter of Example 18 may include, wherein the wearable device comprises a wristband.

In Example 21, the subject matter of Example 18 may include, wherein the wearable device comprises a shoe insert.

In Example 22, the subject matter of any one of Examples 18 to 21 may include, further comprising: providing a user interface to the user to set the physical activity to disable the alarm; and receiving from the user, the physical activity.

In Example 23, the subject matter of any one of Examples 18 to 22 may include, wherein the physical activity comprises running a threshold distance.

In Example 24, the subject matter of any one of Examples 18 to 23 may include, wherein the physical activity comprises taking a threshold number of steps.

In Example 25, the subject matter of any one of Examples 18 to 24 may include, wherein the physical activity comprises performing a threshold number of pushups.

In Example 26, the subject matter of any one of Examples 18 to 25 may include, wherein the physical activity is a portion of a training regimen; and wherein detecting the physical activity performed by the user comprises detecting that the user is complying with the training regimen.

In Example 27, the subject matter of any one of Examples 18 to 26 may include, wherein allowing the alarm to be disabled in response to detecting that the physical activity was performed comprises: unlocking an alarm application on the wearable device; and receiving user input from the user to access the alarm application and disable the alarm.

In Example 28, the subject matter of any one of Examples 18 to 27 may include, wherein allowing the alarm to be disabled in response to detecting that the physical activity was performed comprises: automatically disabling the alarm in response to detecting that the physical activity was performed.

In Example 29, the subject matter of any one of Examples 18 to 28 may include, wherein the physical activity is one of a plurality of physical activities to be performed in a sequence, and wherein detecting the physical activity performed by the user comprises: detecting that the plurality of physical activities were performed by the user in the sequence.

In Example 30, the subject matter of any one of Examples 18 to 29 may include, further comprising: detecting user activity that is related to the physical activity; and suspending the alarm while the user activity is occurring.

In Example 31, the subject matter of any one of Examples 18 to 30 may include, further comprising: selecting the physical activity from a plurality of physical activities; and presenting the physical activity to the user.

In Example 32, the subject matter of any one of Examples 18 to 31 may include, wherein selecting the physical activity from the plurality of physical activities is performed by randomly selecting the physical activity from the plurality of physical activities.

In Example 33, the subject matter of any one of Examples 18 to 32 may include, wherein the plurality of physical activities is identified by the user and wherein the physical activity is randomly selected from the plurality of physical activities.

In Example 34, the subject matter of any one of Examples 18 to 33 may include, wherein the plurality of physical activities is correlated to a plurality of days, and wherein selecting the physical activity comprises: selecting the physical activity based on a current day.

Example 35 includes at least one machine-readable medium including instructions, which when executed by a machine, cause the machine to perform operations of any of the Examples 18-34.

Example 36 includes an apparatus comprising means for performing any of the Examples 18-34.

Example 37 includes subject matter for implementing a wearable alarm clock (such as a device, apparatus, or machine) comprising: means for signaling an alarm from a mobile device associated with a user, the mobile device communicatively coupled to a wearable device worn by the user; means for detecting a physical activity performed by the user; and means for allowing the alarm to be disabled in response to detecting that the physical activity was performed.

In Example 38, the subject matter of Example 37 may include, wherein the wearable device comprises a watch.

In Example 39, the subject matter of Example 37 may include, wherein the wearable device comprises a wristband.

In Example 40, the subject matter of Example 37 may include, wherein the wearable device comprises a shoe insert.

In Example 41, the subject matter of any one of Examples 37 to 40 may include, further comprising: means for providing a user interface to the user to set the physical activity to disable the alarm; and means for receiving from the user, the physical activity.

In Example 42, the subject matter of any one of Examples 37 to 41 may include, wherein the physical activity comprises running a threshold distance.

In Example 43, the subject matter of any one of Examples 37 to 42 may include, wherein the physical activity comprises taking a threshold number of steps.

In Example 44, the subject matter of any one of Examples 37 to 43 may include, wherein the physical activity comprises performing a threshold number of pushups.

In Example 45, the subject matter of any one of Examples 37 to 44 may include, wherein the physical activity is a portion of a training regimen; and wherein the means for detecting the physical activity performed by the user comprises means for detecting that the user is complying with the training regimen.

In Example 46, the subject matter of any one of Examples 37 to 45 may include, wherein the means for allowing the alarm to be disabled in response to detecting that the physical activity was performed comprises: means for unlocking an alarm application on the wearable device; and means for receiving user input from the user to access the alarm application and disable the alarm.

In Example 47, the subject matter of any one of Examples 37 to 46 may include, wherein the means for allowing the alarm to be disabled in response to detecting that the physical activity was performed comprises: means for automatically disabling the alarm in response to detecting that the physical activity was performed.

In Example 48, the subject matter of any one of Examples 37 to 47 may include, wherein the physical activity is one of a plurality of physical activities to be performed in a sequence, and wherein the means for detecting the physical activity performed by the user comprises: means for detecting that the plurality of physical activities were performed by the user in the sequence.

In Example 49, the subject matter of any one of Examples 37 to 48 may include, further comprising: means for detecting user activity that is related to the physical activity; and means for suspending the alarm while the user activity is occurring.

In Example 50, the subject matter of any one of Examples 37 to 49 may include, further comprising: means for selecting the physical activity from a plurality of physical activities; and means for presenting the physical activity to the user.

In Example 51, the subject matter of any one of Examples 37 to 50 may include, wherein the means for selecting the physical activity from the plurality of physical activities is performed by randomly selecting the physical activity from the plurality of physical activities.

In Example 52, the subject matter of any one of Examples 37 to 51 may include, wherein the plurality of physical activities is identified by the user and wherein the physical activity is randomly selected from the plurality of physical activities.

In Example 53, the subject matter of any one of Examples 37 to 52 may include, wherein the plurality of physical activities is correlated to a plurality of days, and wherein the means for selecting the physical activity comprises: means for selecting the physical activity based on a current day.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A wearable alarm clock system, the system comprising:
an alarm module to signal an alarm from a mobile device associated with a user, the mobile device communicatively coupled to a wearable device worn by the user;
an activity module to detect a physical activity performed by the user; and
a user interface module to allow the alarm to be disabled in response to detecting that the physical activity was performed.

2. The system of claim 1, wherein the wearable device comprises a watch.

3. The system of claim 1, wherein the wearable device comprises a wristband.

4. The system of claim 1, wherein the wearable device comprises a shoe insert.

5. The system of claim 1, wherein the user interface module is to:
provide a user interface to the user to set the physical activity to disable the alarm; and
receive from the user, the physical activity.

6. The system of claim 1, wherein the physical activity comprises running a threshold distance.

7. The system of claim 1, wherein the physical activity comprises taking a threshold number of steps.

8. The system of claim 1, wherein the physical activity comprises performing a threshold number of pushups.

9. The system of claim 1, wherein the physical activity is a portion of a training regimen; and wherein to detect the physical activity performed by the user, the activity module is to detect that the user is complying with the training regimen.

10. The system of claim 1, wherein to allow the alarm to be disabled, the user interface module is to:
unlock an alarm application on the wearable device; and
receive user input from the user to access the alarm application and disable the alarm.

11. The system of claim 1, wherein to allow the alarm to be disabled, the user interface module is to:
automatically disable the alarm in response to detecting that the physical activity was performed.

12. The system of claim 1, wherein the physical activity is one of a plurality of physical activities to be performed in a sequence, and wherein to detect the physical activity performed by the user, the activity module is to:
detect that the plurality of physical activities were performed by the user in the sequence.

13. The system of claim 1, wherein the activity module is to detect user activity that is related to the physical activity; and
wherein the alarm module is to suspend the alarm while the user activity is occurring.

14. The system of claim 1, wherein the activity module is to select the physical activity from a plurality of physical activities; and
wherein the user interface module is to present the physical activity to the user.

15. The system of claim 14, wherein to select the physical activity from the plurality of physical activities, the activity module randomly selects the physical activity from the plurality of physical activities.

16. The system of claim 14, wherein the plurality of physical activities is identified by the user and wherein the activity module is to randomly select the physical activity from the plurality of physical activities.

17. The system of claim 14, wherein the plurality of physical activities is correlated to a plurality of days, and wherein to select the physical activity, the activity module is to:
select the physical activity based on a current day.

18. A method of implementing a wearable alarm clock, the method comprising:
signaling an alarm from a mobile device associated with a user, the mobile device communicatively coupled to a wearable device worn by the user;
detecting a physical activity performed by the user; and
allowing the alarm to be disabled in response to detecting that the physical activity was performed.

19. The method of claim 18, further comprising:
providing a user interface to the user to set the physical activity to disable the alarm; and
receiving from the user, the physical activity.

20. The method of claim 18, wherein allowing the alarm to be disabled in response to detecting that the physical activity was performed comprises:
unlocking an alarm application on the wearable device; and
receiving user input from the user to access the alarm application and disable the alarm.

21. At least one machine-readable medium including instructions, which when executed by a machine, cause the machine to:
signal an alarm from a mobile device associated with a user, the mobile device communicatively coupled to a wearable device worn by the user;
detect a physical activity performed by the user; and
allow the alarm to be disabled in response to detecting that the physical activity was performed.

22. The at least one machine-readable medium of claim 21, wherein the physical activity is one of a plurality of physical activities to be performed in a sequence, and wherein the instructions to detect the physical activity performed by the user comprise instructions to:
detect that the plurality of physical activities were performed by the user in the sequence.

23. The at least one machine-readable medium of claim 21, further comprising instructions to:
detect user activity that is related to the physical activity; and
suspend the alarm while the user activity is occurring.

24. The at least one machine-readable medium of claim 21, further comprising instructions to:
select the physical activity from a plurality of physical activities; and
present the physical activity to the user.

25. The at least one machine-readable medium of claim 24, wherein to select the physical activity from the plurality of physical activities is performed by randomly selecting the physical activity from the plurality of physical activities.
